(19) United States
(12) Patent Application Publication
(10) Pub. No.: US 2023/0213792 A1
(43) Pub. Date: Jul. 6, 2023

(54) ELECTRO-OPTIC MODULATOR COMPRISING THIN-FILM OF LITHIUM NIOBATE

(71) Applicant: Huazhong University of Science and Technology, Wuhan (CN)

(72) Inventors: Weihua GUO, Wuhan (CN); Yongqian TANG, Wuhan (CN); Qiaoyin LU, Wuhan (CN)

(21) Appl. No.: 18/093,831

(22) Filed: Jan. 6, 2023

(30) Foreign Application Priority Data
Jan. 6, 2022 (CN) 202210009596.6

(51) Int. Cl. G02F 1/035; G02F 1/03

(52) U.S. Cl. CPC G02F 1/035; G02F 1/0316

(57) ABSTRACT

An electro-optic modulator includes an optical structure and an electrical structure. The optical structure includes an input waveguide, a beam splitter, a first waveguide arm, a second waveguide arm, a beam combiner, and an output waveguide; each of the first waveguide arm and the second waveguide arm includes a conventional waveguide region. The first waveguide arm further includes a first modulating region, a second modulating region, and a third modulating region. The second waveguide arm further includes a fourth modulating region, a fifth modulating region, and a sixth modulating region; the electrical structure includes a traveling wave electrode including a signal-ground-signal electrode structure. The traveling wave electrode further includes a signal input region, a modulating electrode region, and a matched resistor region. The modulating electrode region includes a first signal electrode, a ground electrode, and a second signal electrode.

### CROSS-REFERENCE TO RELATED APPLICATIONS

Pursuant to 35 U.S.C. § 119 and the Paris Convention Treaty, this application claims foreign priority to Chinese Patent Application No. 202210009596.6 filed Jan. 6, 2022, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to the field of an electro-optic modulator comprising a thin film of lithium niobate.

A lithium niobate thin film has a greater refractive index difference than a conventional lithium niobate waveguide. Thus, electrodes can be arranged close to the waveguide, increasing the modulation efficiency. Low dielectric constant substrate materials, such as silicon or quartz, have low refractive indices, thus reducing the microwave refractive index, and being easy to match the refractive index of optical waves. For a modulator made of a lithium niobate thin film, low half-wave voltages and large modulation bandwidth are also easily achieved.

The thin-film lithium niobate modulator usually adopts X-cut thin-film lithium niobate material. Even a single ended modulator can achieve the differential modulation effect of silicon and indium phosphide (InP) modulator. Because many drivers are differential drivers designed specifically for silicon modulators and InP modulators, an X-cut thin-film lithium niobate modulator that is compatible with these drivers is required. Furthermore, the electrical loss limits the bandwidth of the thin-film lithium niobate modulator. To minimize the modulation voltage, the length of the waveguide arm is often increased, resulting in an electrical loss that affects the modulation bandwidth.

### SUMMARY

To solve the aforesaid problems, the disclosure provides an electro-optic modulator comprising a thin film of lithium niobate.

The electro-optic modulator comprises an optical structure and an electrical structure.

The optical structure comprises an input waveguide, a beam splitter, a first waveguide arm, a second waveguide arm, a beam combiner, and an output waveguide; each of the first waveguide arm and the second waveguide arm comprises a conventional waveguide region; the first waveguide arm further comprises a first modulating region, a second modulating region, and a third modulating region; the second waveguide arm further comprises a fourth modulating region, a fifth modulating region, and a sixth modulating region;

the electrical structure comprises a traveling wave electrode comprising a signal-ground-signal electrode structure; the traveling wave electrode further comprises a signal input region, a modulating electrode region, and a matched resistor region;

the modulating electrode region comprises a first signal electrode, a ground electrode, and a second signal electrode; the first modulating region is disposed between the first signal electrode and the ground electrode; the fourth modulating region is disposed between the second signal electrode and the ground electrode; and the matched resistor region comprises a virtual ground electrode, a first matched resistor, a second matched resistor, a third matched resistor, and a capacitor; the first signal electrode is connected to the virtual ground electrode via the first matched resistor; the second signal electrode is connected to the virtual ground electrode via the second matched resistor; the ground electrode is connected to the virtual ground electrode via the third matched resistor and the capacitor.

In a class of this embodiment, the optical structure comprises a thin film of X-cut lithium niobate; the optical structure comprises a substrate, a first cladding, a lithium niobate thin film and a second cladding disposed successively from bottom to top; both the first cladding and the second cladding have a low refractive index; a direction perpendicular to the lithium niobate thin film is labelled as X-direction; directions in a plane of the lithium niobate thin film are labelled as Z-direction and Y-direction; a direction of an electric field applied between the first or second signal electrode and the ground electrode is labelled as the Z-direction; a waveguide direction of the first or second modulating region is labelled as the Y-direction; in the optical structure, an optical waveguide is formed by etching the lithium niobate thin film, depositing a patterned waveguide on the lithium niobate thin film, or a combination thereof.

In a class of this embodiment, two ferroelectric domains are respectively formed in the first modulating region and the fourth modulating region, and polarized in opposite directions; and a high electric field is applied to reverse the two ferroelectric domains in opposite directions.

In a class of this embodiment, differential signals are applied to the traveling wave electrode; a positive voltage V is applied between the first signal electrode and the ground electrode, and a negative voltage −V is applied between the second signal electrode and the ground electrode.

In a class of this embodiment, the first waveguide arm, the second waveguide arm, and the traveling wave electrode each have a bent structure.

In a class of this embodiment, the first waveguide arm is disposed between the first signal electrode and the ground electrode; and the second waveguide arm is disposed between the second signal electrode and the ground electrode.

In a class of this embodiment, the first modulating region, the second modulating region, and the third modulating region of the first waveguide arm are connected in a bent waveguide, and polarization directions of ferroelectric domains of every two adjacent modulating regions of the first waveguide arm are opposite to each other.

In a class of this embodiment, the fourth modulating region, the fifth modulating region, and the sixth modulating region of the second waveguide arm are respectively corresponding to the first modulating region, the second modulating region, and the third modulating region of the first waveguide arm, and polarization directions of ferroelectric domains of every two adjacent modulating regions of the second waveguide arm are opposite to each other.

In a class of this embodiment, the first waveguide arm and the second waveguide arm intersect in the bent waveguide; the first modulating region of the first waveguide arm is disposed between the first signal electrode and the ground electrode; after a first intersection, the second modulating region of the first waveguide arm is disposed between the ground electrode and the second signal electrode; after a second intersection, the third modulating region of the first waveguide arm is disposed between the first signal electrode and the ground electrode.

In a class of this embodiment, the fourth modulating region, the fifth modulating region, and the sixth modulating region of the second waveguide arm are corresponding to the first modulating region, the second modulating region, and the third modulating region of the first waveguide arm, and the polarization directions of ferroelectric domains of every two corresponding modulating regions are opposite to each other.

The following advantages are associated with the electro-optic modulator of the disclosure:

The electro-optic modulator of the disclosure is differentially driven to reduce the loss in the traveling wave electrode; when the waveguide arms and the traveling wave electrode are bent separately, the electro-optic modulator features low half-wave voltage, low insertion loss and high modulation bandwidth, which facilitates the miniaturization and high integration of the modulators.

### DETAILED DESCRIPTION OF THE DRAWINGS

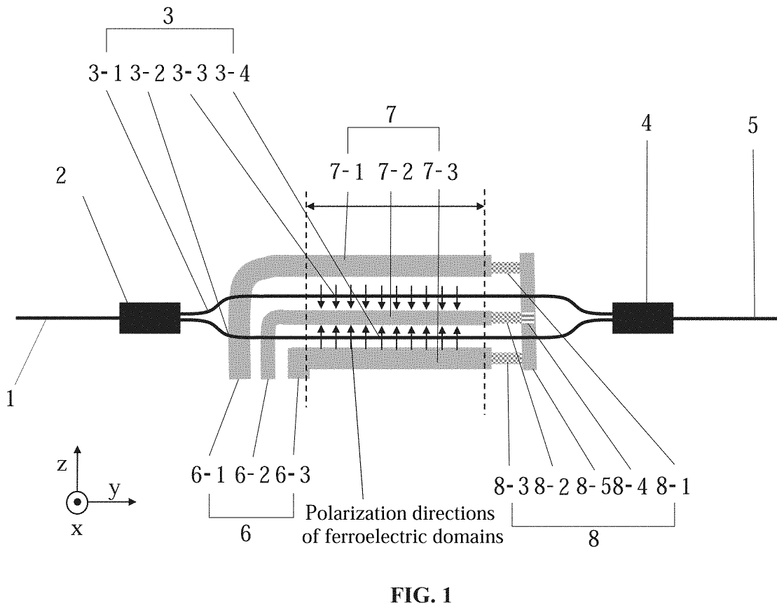

FIG. 1 is a top view of an electro-optic modulator according to Example 1 of the disclosure;

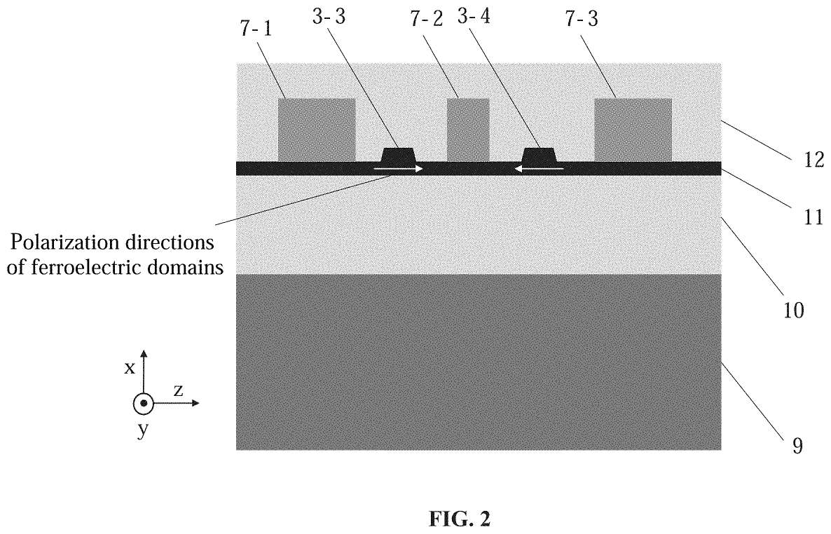

FIG. 2 is a cross-sectional view of a traveling wave electrode according to Example 1 of the disclosure;

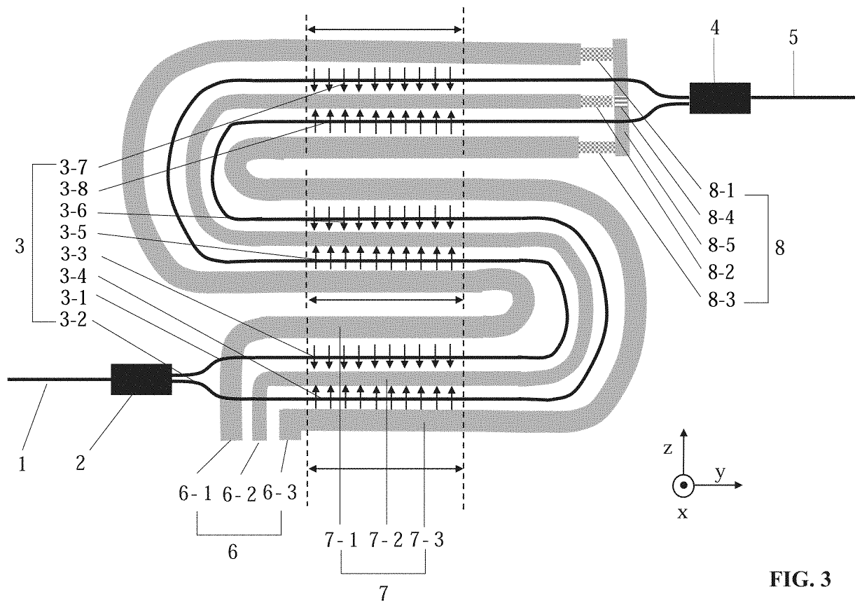

FIG. 3 is a top view of an electro-optic modulator according to Example 2 of the disclosure;

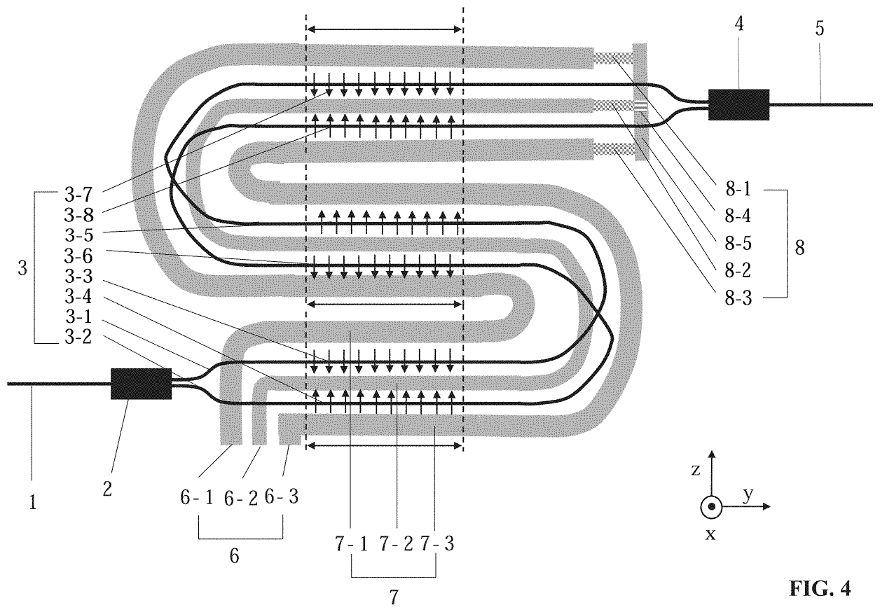

FIG. 4 is a top view of an electro-optic modulator according to Example 3 of the disclosure;

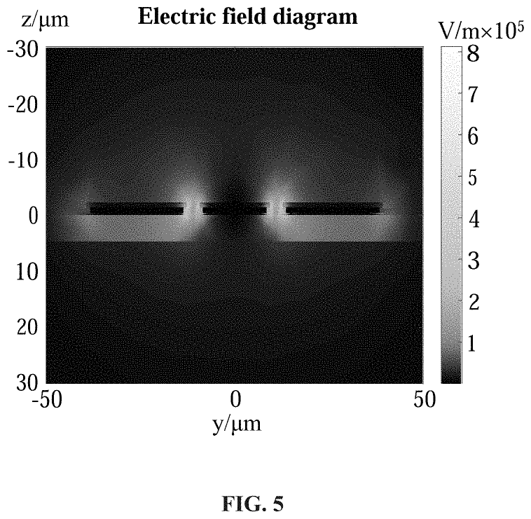

FIG. 5 is a schematic diagram of an electric field applied to a traveling wave electrode according to Example 1 of the disclosure;

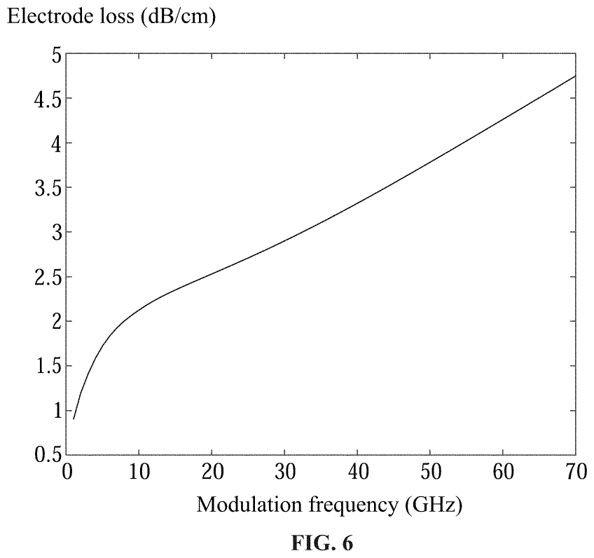

FIG. 6 is a graph of loss in a traveling wave electrode versus modulation frequency according to Example 1 of the disclosure;

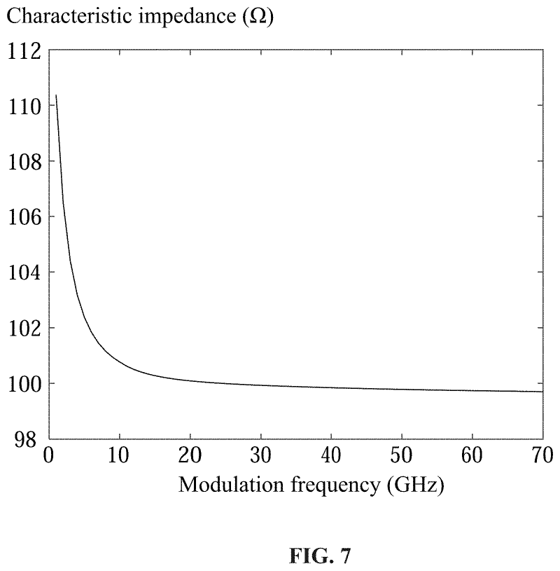

FIG. 7 is a graph of characteristic impedance of a traveling wave electrode versus modulation frequency according to Example 1 of the disclosure;

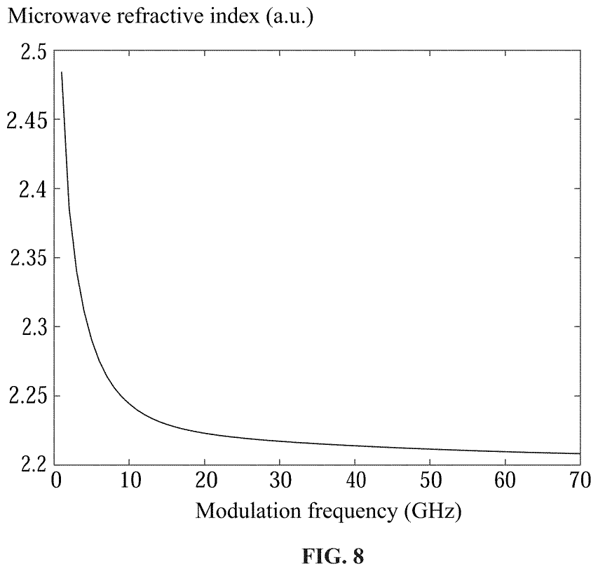

FIG. 8 is a graph of microwave refractive index of a traveling wave electrode versus modulation frequency according to Example 1 of the disclosure; and

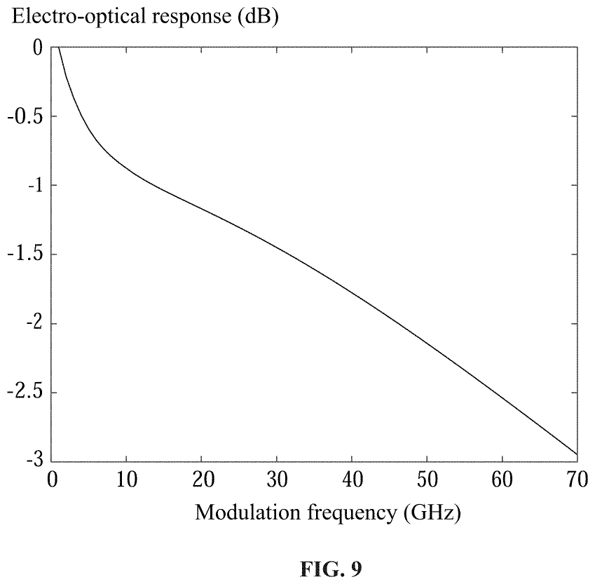

FIG. 9 is a graph of small-signal modulation bandwidth versus modulation frequency according to Example 1 of the disclosure.

In the drawings, the following reference numbers are used: 1. Input waveguide; 2. Beam splitter; 3. Waveguide arm; 3-1. First waveguide arm; 3-2. Second waveguide arm; 3-3. First modulating region; 3-4. Fourth modulating region; 3-5. Second modulating region; 3-6. Fifth modulating region; 3-7. Third modulating region; 3-8. Sixth modulating region; 4. Beam combiner; 5. Output waveguide; 6. Signal input region; 6-1. First signal electrode in signal input region; 6-2. Ground electrode in signal input region; 6-3. Second signal electrode in signal input region; 7. Modulating electrode region; 7-1. First signal electrode; 7-2. Ground electrode; 7-3. Second signal electrode; 8. Matched resistor region; 8-1. First matched resistor; 8-2. Third matched resistor; 8-3. Second matched resistor; 8-4. Capacitor; 8-5. Virtual ground electrode; 9. Substrate; 10. First cladding; 11. Lithium niobate thin film; and 12. Second cladding.

### DETAILED DESCRIPTION OF THE EMBODIMENTS

To further illustrate, embodiments detailing an electro-optic modulator are described below. It should be noted that the following embodiments are intended to describe and not to limit the disclosure.

### Example 1

Referring FIGS. 1, 2, 5, 6, 7, 8, and 9, an electro-optic modulator comprises an optical structure and an electrical structure.

The optical structure comprises an input waveguide 1, a beam splitter 2, two waveguide arms 3, a beam combiner 4, and an output waveguide 5; the two waveguide arms comprise a first waveguide arm 3-1 and a second waveguide arm 3-2 each comprising a conventional waveguide region and a modulating region. The first waveguide arm 3-1 further comprising a first modulating region 3-3; the second waveguide arm 3-2 further comprising a fourth modulating region 3-4.

The electrical structure comprises a traveling wave electrode comprising a signal-ground-signal electrode structure; the traveling wave electrode further comprises a signal input region 6, a modulating electrode region 7, and a matched resistor region 8. The signal input region 6 comprises a first signal electrode 6-1, a ground electrode 6-2, and a second signal electrode 6-3.

The modulating electrode region 7 comprises a first signal electrode 7-1, a ground electrode 7-2, and a second signal electrode 7-3; the modulating regions are disposed between the first signal electrode and the ground electrode as well as between the ground electrode and the second signal electrode; the matched resistor region comprises a virtual ground electrode 8-5, a first matched resistor 8-1, a second matched resistor 8-3, a third matched resistor 8-2, and a capacitor 8-4; the first signal electrode is connected to the virtual ground electrode via the first matched resistor; the second signal electrode 7-3 is connected to the virtual ground electrode 8-5 via the second matched resistor 8-3; the ground electrode 7-2 is connected to the virtual ground electrode 8-5 via the third matched resistor 8-2 and the capacitor 8-4.

The optical structure comprises a thin film of X-cut lithium niobate; specifically, the optical structure comprises a substrate 9, a first cladding 10, a lithium niobate thin film 11 and a second cladding 12 disposed successively from bottom to top; both the first cladding and the second cladding have a low refractive index; a direction perpendicular to the lithium niobate thin film 11 is labelled as X-direction; directions in the plane of the lithium niobate thin film are labelled as Z-direction and Y-direction; a direction of an electric field applied between the signal electrodes and the ground electrode is labelled as Z-direction; a direction parallel to the waveguides is labelled as Y-direction; in the optical structure, an optical waveguide is formed by etching the lithium niobate thin film, depositing a patterned waveguide on the lithium niobate thin film, or a combination thereof.

Further, ferroelectric domains are formed in the two modulating regions and polarized in opposite directions; and a high electric field is applied to reverse the two ferroelectric domains in opposite directions.

Further, differential signals are applied to the traveling wave electrode and comprises a positive voltage signal and a negative voltage signal; in other words, a positive voltage V is applied between the first signal electrode and the ground electrode; a negative voltage −V is applied between the second signal electrode and the ground electrode.

Further, in this example, the traveling wave electrode comprises a coplanar waveguide structure. The traveling wave electrode comprises an Aurum (Au) layer with a thickness of 1.1 μm; the first signal electrode and the second signal electrode separately have a width of 25 μm; the ground electrode has a width of 17 μm; a distance between the first signal electrode and the ground electrode is 5 μm; and a distance between the second signal electrode and the ground electrode is 5 μm.

Further, in the example, the substrate comprises silicon (Si) having a refractive index of 3.49, a relative dielectric constant is 11.9, and a thickness is 500 μm; the first cladding comprises SiO₂ having a refractive index of 1.44, a relative dielectric constant is 3.9, and a thickness is 4.7 μm; the lithium niobate thin film has a thickness of 0.6 μm, an extraordinary refractive index of nₑ=2.1376; an ordinary refractive index of nₒ=2.2111, an extraordinary relative dielectric constant is ε_{c}=27.9, and an ordinary relative dielectric constant is εₒ=44.3; and the second cladding 12 comprises SiO₂ having a refractive index of 1.44, a relative dielectric constant is 3.9, and a thickness is 0.8 μm;

Further, in the example, the two waveguide arms are ridge waveguides each having a width of 1.5 μm and a height of 0.3 μm; and each ridge waveguide comprises a sidewall with an inclination angle of 76°.

Further, in the example, the signal input region 6 is connected to the modulating electrode region via a bent structure; the modulating electrode region 7 has the same length L of 1.5 cm as the modulating region of each waveguide arm.

Further, in the example, the first matched resistor and the second matched resistor separately has a resistance of 50Ω, which matches the differential impedance of 100Ω, thereby reducing the reflection of the differential-mode signal.

Further, in the example, the traveling wave electrode is connected to the virtual ground electrode through the third matched resistor having a resistance of 50Ω, which reduces the reflection of the residual common mode signal; the capacitor is disposed between the third matched resistor and the virtual ground electrode to block DC current.

The working principle of the electro-optic modulator in Example 1: the input light enters into the input waveguide, is split into two beams by the beam splitter, and respectively enters the first waveguide arm and the second waveguide arm; a differential radio-frequency (RF) signal travels through the signal input region, enters the traveling wave electrode, and propagates simultaneously with the two optical signals. Since the ferroelectric domains are formed in the two modulating regions and polarized in opposite directions, phases in upper and lower waveguide arms are gradually accumulated and modulated in opposite so as to achieve a push-pull operation with high modulation efficiency. The beam combiner merges the two optical signals passing through the first arm and the second arm, so as to convert phase information into intensity data and output a modulated optical signal.

### Example 2

Referring to FIGS. 1, 2, 3, 5, 6, 7, 8, and 9, on the basis of Example 1, the two waveguide arms and the traveling wave electrode each have a bent structure; the first waveguide arm is disposed between the first signal electrode and the ground electrode; the second waveguide arm is disposed between the second signal electrode and the ground electrode; the first waveguide arm comprises of a first modulating region 3-3, a second modulating region 3-5, and a third modulating region 3-7, which are connected in a bent waveguide to form the first ferroelectric domains, and polarization directions of ferroelectric domains of every two adjacent modulating regions of the first waveguide arm are opposite to each other.; the second waveguide arm comprises of a fourth modulating region 3-4, a fifth modulating region 3-6, and a sixth modulating region 3-8, which are respectively corresponding to the first waveguide arm to form the second ferroelectric domains that are polarized in opposite directions; the first ferroelectric domains and the second ferroelectric domains are polarized in opposite directions.

The working principle of the electro-optic modulator in Example 2: the input light enters into the input waveguide, is split into two beams by the beam splitter, and respectively enters the first arm and the second arm; an RF signal travels through the signal input region, enters the traveling wave electrode, and propagates simultaneously with the two optical signals. The differential RF signal and the optical signals are directed in a specific direction by each bent waveguide. The modulating regions on the same waveguide arm are connected via each bent waveguide. The ferroelectric domains are polarized in the opposite direction; the traveling wave electrode is curved into the same shape as the two waveguide arms; phases in the two waveguide arms are gradually accumulated and modulated in opposite due to the differential signaling so as to achieve a push-pull operation with high modulation efficiency.

The beam combiner merges the two optical signals passing through the first arm and the second arm, so as to convert phase information into intensity data and output a modulated optical signal.

### Example 3

Referring to FIGS. 1-9, on the basis of Example 2, the first waveguide arm and the second waveguide arm intersect in the bent waveguide; the plurality of first modulating regions is connected via each bent waveguide, so that the first waveguide arm is disposed, first between the first signal electrode and the ground electrode, then between the second signal electrode and the ground electrode, then between the first signal electrode and the ground electrode, and so on; the first ferroelectric domains are polarized in opposite directions; the plurality of second modulating regions is disposed corresponding to the plurality of first modulating regions; the first ferroelectric domains and the second ferroelectric domains are polarized in opposite directions.

### Example 3 and Example 2 Share the Same Principle

A finite element method is used to model the optical structure and the traveling wave electrode structure in Example 1. At 1550 nm wavelength, a loss in the modulation waveguide is less than 0.1 dB/cm, and a group refractive index is n_{g}=2.258.

The modulation efficiency of the electro-optic modulator is expressed as the voltage-length product (Vπ·L), and is calculated to be 2.2 V·cm by electrostatic simulation. The modulating region has a length of 1.5 cm and is driven at a modulation voltage Vπ of 1.46 V.

The electro-optical modulator is in a differentially driven configuration and performs an RF simulation; the results show that a differential impedance of the traveling wave electrode is 100Ω and a loss in the traveling wave electrode is 0.44 dBcm⁻¹ GHz^{-0.5}, which is less than a conventional traveling wave electrode configured into a common mode. A microwave refractive index is 2.21. FIGS. 5-8 illustrates the results of RF simulation according to Example 1 of the disclosure.

FIG. 9 illustrates characteristic electro-optical response curve. The results show that the small-signal 3 dB modulation bandwidth of Example 1 is greater than 70 GHz.

The electro-optic modulator of the disclosure is differentially driven to reduce the loss in the traveling wave electrode; when the waveguide arms and the traveling wave electrode separately are bent separately, the electro-optic modulator features low half-wave voltage, low insertion loss and high modulation bandwidth, which facilitates the miniaturization and high integration of the modulators.

It will be obvious to those skilled in the art that changes and modifications may be made, and therefore, the aim in the appended claims is to cover all such changes and modifications.

What is claimed is:

1. An electro-optic modulator, comprising:
1) an optical structure, the optical structure comprising an input waveguide, a beam splitter, a first waveguide arm, a second waveguide arm, a beam combiner, and an output waveguide; each of the first waveguide arm and the second waveguide arm comprising a conventional waveguide region; the first waveguide arm further comprising a first modulating region, a second modulating region, and a third modulating region; the second waveguide arm further comprising a fourth modulating region, a fifth modulating region, and a sixth modulating region; and
2) an electrical structure, the electrical structure comprising a traveling wave electrode comprising a signal-ground-signal electrode structure; the traveling wave electrode further comprising a signal input region, a modulating electrode region, and a matched resistor region;
wherein:
the modulating electrode region comprises a first signal electrode, a ground electrode, and a second signal electrode;
the first modulating region is disposed between the first signal electrode and the ground electrode; the fourth modulating region is disposed between the second signal electrode and the ground electrode; and
the matched resistor region comprises a virtual ground electrode, a first matched resistor, a second matched resistor, a third matched resistor, and a capacitor; the first signal electrode is connected to the virtual ground electrode via the first matched resistor; the second signal electrode is connected to the virtual ground electrode via the second matched resistor; the ground electrode is connected to the virtual ground electrode via the third matched resistor and the capacitor.

2. The modulator of claim 1, wherein the optical structure comprises a thin film of X-cut lithium niobate; the optical structure comprises a substrate, a first cladding, a lithium niobate thin film and a second cladding disposed successively from bottom to top; both the first cladding and the second cladding have a low refractive index; a direction perpendicular to the lithium niobate thin film is labelled as X-direction; directions in a plane of the lithium niobate thin film are labelled as Z-direction and Y-direction; a direction of an electric field applied between the first or second signal electrode and the ground electrode is labelled as the Z-direction; a waveguide direction of the first or second modulating region is labelled as the Y-direction; in the optical structure, an optical waveguide is formed by etching the lithium niobate thin film, depositing a patterned waveguide on the lithium niobate thin film, or a combination thereof.

3. The modulator of claim 1, wherein two ferroelectric domains are respectively formed in the first modulating region and the fourth modulating region, and polarized in opposite directions; and a high electric field is applied to reverse the two ferroelectric domains in opposite directions.

4. The modulator of claim 1, wherein differential signals are applied to the traveling wave electrode; a positive voltage V is applied between the first signal electrode and the ground electrode, and a negative voltage −V is applied between the second signal electrode and the ground electrode.

5. The modulator of claim 1, wherein the first waveguide arm, the second waveguide arm, and the traveling wave electrode each have a bent structure.

6. The modulator of claim 5, wherein the first waveguide arm is disposed between the first signal electrode and the ground electrode; and the second waveguide arm is disposed between the second signal electrode and the ground electrode.

7. The modulator of claim 6, wherein the first modulating region, the second modulating region, and the third modulating region of the first waveguide arm are connected in a bent waveguide, and polarization directions of ferroelectric domains of every two adjacent modulating regions of the first waveguide arm are opposite to each other.

8. The modulator of claim 7, wherein the fourth modulating region, the fifth modulating region, and the sixth modulating region of the second waveguide arm are respectively corresponding to the first modulating region, the second modulating region, and the third modulating region of the first waveguide arm, and polarization directions of ferroelectric domains of every two adjacent modulating regions of the second waveguide arm are opposite to each other.

9. The modulator of claim 8, wherein the first waveguide arm and the second waveguide arm intersect in the bent waveguide; the first modulating region of the first waveguide arm is disposed between the first signal electrode and the ground electrode; after a first intersection, the second modulating region of the first waveguide arm is disposed between the ground electrode and the second signal electrode; after a second intersection, the third modulating region of the first waveguide arm is disposed between the first signal electrode and the ground electrode.

10. The modulator of claim 9, wherein the fourth modulating region, the fifth modulating region, and the sixth modulating region of the second waveguide arm are corresponding to the first modulating region, the second modulating region, and the third modulating region of the first waveguide arm, and the polarization directions of ferroelectric domains of every two corresponding modulating regions are opposite to each other.
